(19) United States
(12) Patent Application Publication
(10) Pub. No.: US 2018/0068328 A1
(43) Pub. Date: Mar. 8, 2018

(54) METHODS AND SYSTEMS FOR PROVIDING AN ONLINE POLL VIA A SYMBOLOGY

(71) Applicant: PAYCHIEF LLC, New York, NY (US)

(72) Inventors: Andre Gustavo VELLOZO LUZ, Sao Paulo-SP (BR); Mauricio GHETLER, Sao Paulo-SP (BR)

(21) Appl. No.: 15/807,093

(22) Filed: Nov. 8, 2017

Related U.S. Application Data
(62) Division of application No. 13/527,700, filed on Jun. 20, 2012, now abandoned.

(51) Int. Cl. G06Q 30/02

(52) U.S. Cl. CPC G06Q 30/0201

(57) ABSTRACT

Methods and systems for managing, receiving, responding to, and preparing polls accessible via mobile electronic devices are disclosed. A mobile electronic device may capture an image of a poll symbology and determine whether the poll symbology is in an expected format. The mobile electronic device may decode the poll symbology to form a sequence and transmit the sequence to a remote computing device. The remote computing device may determine whether the code is valid and transmit a poll including a plurality of response items and that is associated with the sequence to the mobile computing device. The mobile electronic device may identify a selected response item based on a user input and transmit information pertaining to the selected response item to the remote computing device. The remote computing device may store the selected response item and perform one or more actions associated with the selected response items if necessary.

### BACKGROUND

Recently, the use of mobile technologies, such as smartphones and the like, has rapidly increased. This increase has resulted in part from the porting of technologies to mobile devices that were once limited to non-mobile applications. Mobile technologies provide the promise of more efficient use of time by allowing interactions with other people and institutions at any time and place.

The use of symbologies has become more prevalent with the increased usage of mobile device technologies. Symbologies provide a means for communicating a substantial amount of information in a limited space. Mobile devices commonly include, for example, Quick Response (QR) code reader applications to enable the user to access data from various sources.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of managing an online poll may include receiving, by a computing device, a sequence representing a poll symbology from a mobile electronic device of a user, determining, by the computing device, whether the sequence corresponds to a poll of one or more polls stored in a database, transmitting, by the computing device, the poll including a plurality of response items to the mobile electronic device, receiving, by the computing device, a selected response item from the plurality of response items from the mobile electronic device, and storing, by the computing device, the selected response item.

In an embodiment, a method of receiving and responding to a poll via a mobile electronic device may include capturing, by the mobile electronic device, an image of a poll symbology, determining, by the mobile electronic device, whether the poll symbology is in an expected format, decoding, by the mobile electronic device, the poll symbology to form a sequence, transmitting, by the mobile electronic device, the sequence to a remote computing device, receiving, by the mobile electronic device, a poll including a plurality of response items and that is associated with the sequence from the remote computing device, identifying, by the mobile electronic device, a selected response item of the plurality of response items based on a user input, and transmitting information pertaining to the selected response item to the remote computing device.

In an embodiment, a method of registering a poll for access via a mobile electronic device may include receiving, by a computing device, poll information including a plurality of response items from an inquirer, storing, by the computing device, the poll information, generating, by the computing device, a poll symbology in response to receiving the poll information, and providing, by the computing device, the symbology to the inquirer.

In an embodiment, a system for receiving and responding to a poll may include a computing device, and a processor-readable storage medium in communication with the computing device. The processor-readable storage medium may contain one or more programming instructions that, when executed, cause the computing device to capture an image of a poll symbology, determine whether the poll symbology is in an expected format, decode the poll symbology to form a sequence, transmit the sequence to a remote computing device, receive a poll including a plurality of response items and that is associated with the sequence from the remote computing device, select a response item of the plurality of response items based on a user input, and transmit information pertaining to the selected response item to the remote computing device.

### BRIEF DESCRIPTION OF THE DRAWINGS

FIG. 1 depicts a flow diagram of an illustrative method of managing an online poll according to an embodiment.

FIG. 2 depicts a flow diagram of an illustrative method of receiving and responding to a poll via a mobile electronic device according to an embodiment.

FIG. 3 depicts a flow diagram of an illustrative method of providing a poll for access via a mobile electronic device according to an embodiment.

FIG. 4 depicts an illustrative mobile electronic device being used to capture a poll symbology from a displayed location according to an embodiment.

FIG. 5 depicts an illustrative mobile electronic device displaying a poll according to an embodiment.

FIG. 6 depicts a block diagram of illustrative internal hardware that may be used to contain or implement program instructions according to an embodiment.

### DETAILED DESCRIPTION

The following terms shall have, for the purposes of this application, the respective meanings set forth below.

As used herein, the terms “sum,” “product” and similar mathematical terms are construed broadly to include any method or algorithm in which a single datum is derived or calculated from a plurality of input data.

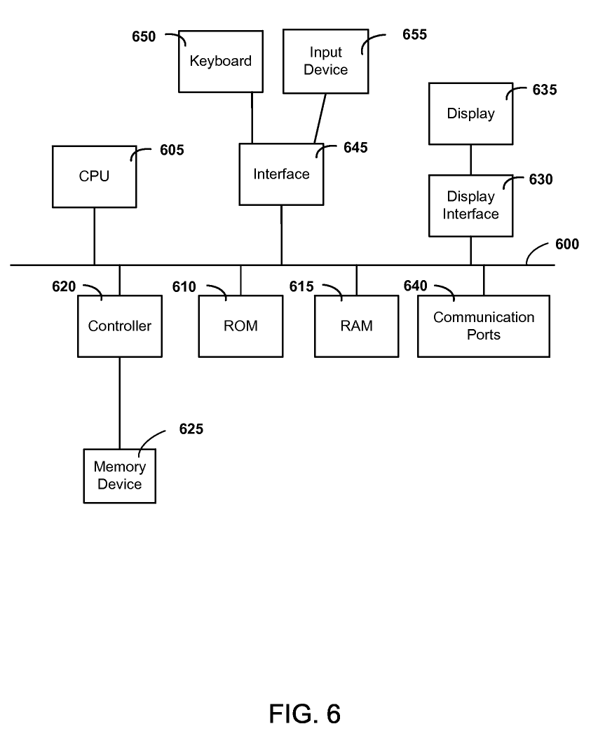

A “computing device” refers to a computer, a processor and/or any other component, device or system that performs one or more operations according to one or more programming instructions. An illustrative computing device is described in reference to FIG. 6.

“Demographic information” refers to any information pertaining to a person or a group of people that is used to identify a characteristic of that person or group. For example, demographic information may include, without limitation, age, gender, height, weight, race, ethnicity, sexual orientation, highest schooling achieved, experience level, hobbies, interests, employment status, and/or the like.

“Location information” refers to any information that identifies a precise or approximate position of a person or a device. Location information may include global positioning satellite (GPS) information, a location identified by a mobile device tracking scheme and/or the like.

A “mobile electronic device” refers to a portable device that is capable of interfacing with other devices via a wireless communication scheme. A mobile electronic device may include a processor and a tangible, computer-readable memory. The memory may contain programming instructions that, when executed by the processor, cause the device to perform one or more operations. Examples of electronic devices include personal computers, gaming systems, smartphones, personal digital assistants, cameras, tablet computers, laptop computers, GPS navigation devices, media players and the like.

A “response item” refers to a listing in a poll that is independently selectable. For example, a poll posing a particular question may have the following four response items: Agree, Neutral, Disagree and Not Sure. Alternate and/or additional response items may be used as selectable items in response to a poll question. In some cases, a response item may be associated with a symbology. In some cases, selection of a response item by a user of a mobile electronic device may trigger an action to be performed on the mobile electronic device or on a computing device remotely connected with the mobile computing device.

A “sequence” refers to one or more alphanumeric characters. A sequence may represent information encapsulated in a poll symbology.

A “symbology” refers to a pattern, a symbol, an image or the like, as well as a portion or a combination thereof, that is displayed on a substrate. The symbology provides an optical, electronically-readable encoded representation of data. Symbologies may include, without limitation, one-dimensional barcodes, two-dimensional (2D) barcodes, or three-dimensional (3D) barcodes. Examples of two-dimensional barcodes include data matrix codes, quick response (QR) codes, Aztec codes, Maxi codes and the like. Symbologies may be of any geometric shape or size. The terms “barcode” and “matrix code” as used herein are each intended to include any type of symbology.

The present disclosure is directed to methods and systems for preparing, accessing, providing and responding to polls. An inquirer may prepare a poll in order to elicit information from individuals. In addition, according to the teachings herein, the inquirer may enable the individuals submitting response to the poll to initiate actions in accordance with their responses.

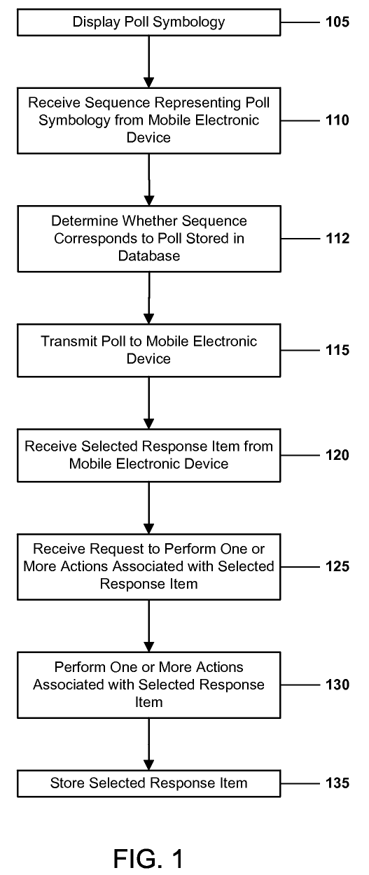

FIG. 1 depicts a flow diagram of an illustrative method of managing an online poll according to an embodiment. As shown in FIG. 1, a poll symbology may be displayed 105. The poll symbology may include a multi-dimensional bar code. In particular, the poll symbology may include a quick response (QR) code, which is a commonly used two-dimensional bar code.

In an embodiment, the poll symbology may be displayed 105 as part of a television program or advertisement. In such an embodiment, the poll symbology may be displayed on a portion of the screen with accompanying text directing the watcher to scan the poll symbology. Additionally or alternatively, verbal information may be provided to the watcher as part of the television program or advertisement directing them to scan the poll symbology. A watcher may be alerted to the poll symbology and/or its intended purpose via additional or alternate means within the scope of this disclosure.

In an embodiment, the poll symbology may be displayed 105 in an electronic format over a computer, such as on an Internet website, in an email message, as part of a message on an electronic message board, as part of an Internet advertisement and/or the like. Accompanying directions, such as textual or audible directions, may be provided in order to direct an individual to scan the poll symbology.

In an embodiment, the poll symbology may be displayed 105 in a tangible or physical format, such as a poster, a product display, or other physical advertisement in a store, a periodical, a paper format, or the like. Similar to the above embodiments, directions may be provided in order to direct an individual to scan the poll symbology.

A computing device may receive 110 a sequence representing the poll symbology from a mobile electronic device of a user. The sequence may be determined based on decoding the poll symbology. For example, the poll symbology may be decoded on the mobile electronic device, as discussed further below. The sequence may include one or more alphanumeric characters, such as one or more binary characters.

The computing device may determine 112 whether the sequence corresponds to a poll of one or more polls stored in a database. For example, the computing device may determine whether the sequence corresponds to any poll entered in the database. In an embodiment, the computing device may determine whether the poll is currently active or whether the poll has expired. Such an embodiment may be used if a poll must be completed within an identified period of time. In an embodiment, the computing device may determine whether a previous response has been received from the mobile electronic device. Such an embodiment may be used if a poll allows only a single response or a limited number of responses to be submitted from a mobile electronic device. In an embodiment, the computing device may determine whether a user is permitted to respond to the poll. Such an embodiment may be used if a poll requires responding users to meet certain criteria, such as an age restriction, a geographic restriction or the like. Additional and/or alternate determinations may be made within the scope of this disclosure.

The computing device may transmit 115 a poll to the mobile electronic device from which the scanned version of the poll symbology was received 110. The poll may be transmitted 115 in response to receiving 110 the scanned version of the poll symbology. The poll may include a plurality of response items. Each response item may include an allowable response to a poll question that is posed as part of the poll.

In an embodiment, a tangible storage medium in operable communication with the computing device may include information pertaining to a plurality of polls. The computing device may process the scanned version of the poll symbology to identify the poll of the plurality of polls that is associated with the poll symbology.

The computing device may receive 120 a selected response item from the mobile electronic device. The selected response item may be one of the plurality of response items transmitted 115 to the mobile electronic device by the computing device. The selected response item may be represented by an alphanumeric value, a scanned version of an image symbology, or any similar representation used to identify a selection by the user of the mobile electronic device.

In an embodiment, the computing device may receive 125 a request to perform one or more actions associated with the selected response item from the mobile electronic device. The computing device may perform 130 the one or more actions upon receipt of the request.

The computing device may store 135 the selected response item. Storing 135 the selected response item may include storing information pertaining to the selected response item and/or information pertaining to the user of the mobile device that provided the selection of the selected response item. The selected response item may be stored 135 in a database or other construct used to enable data aggregation for selected responses from a plurality of users. As such, statistical information may be provided to users based on the user's response and the responses of other users.

For example, the computing device may receive location information from the mobile electronic device. The computing device may transmit statistical information for the poll to the mobile electronic device based on the location information. The statistical information may include aggregated information regarding users responding to the poll in one or more areas, such as a geographical area including the location from which the mobile electronic device transmitted the selected response information, based on the location information. The one or more areas may include similar geographical areas as well. For example, the one or more areas may include states, counties, cities, zip codes, area codes, or the like. Additional and/or alternate areas may be used within the scope of this disclosure.

Similarly, the computing device may receive demographic information from the mobile electronic device. The computing device may transmit statistical information for the poll to the mobile electronic device based on the demographic information. The demographic information may include aggregated information regarding users responding to the poll based on one or more demographic categories, such as age, gender, height, weight, race, ethnicity, sexual orientation, highest schooling achieved, experience level, hobbies, interests, employment status, and/or the like. The one or more demographic categories displayed to a user may include a demographic category to which the user belongs. One or more additional and/or alternate demographic categories may be displayed to a user, such as demographic categories that do not include the user of the mobile electronic device submitting the selected response, but that are related to the demographic category including the user.

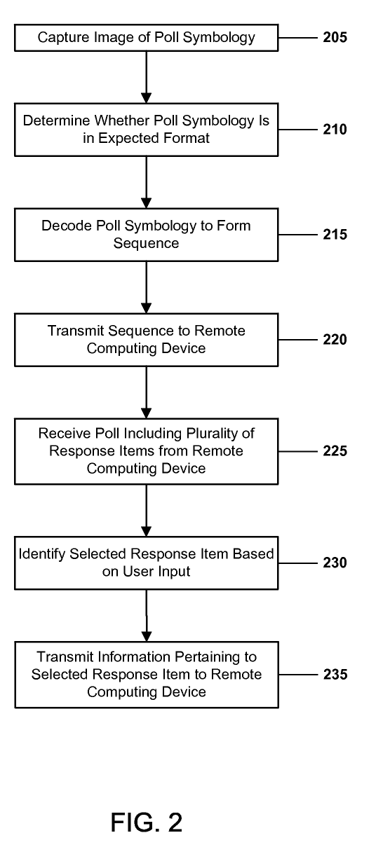

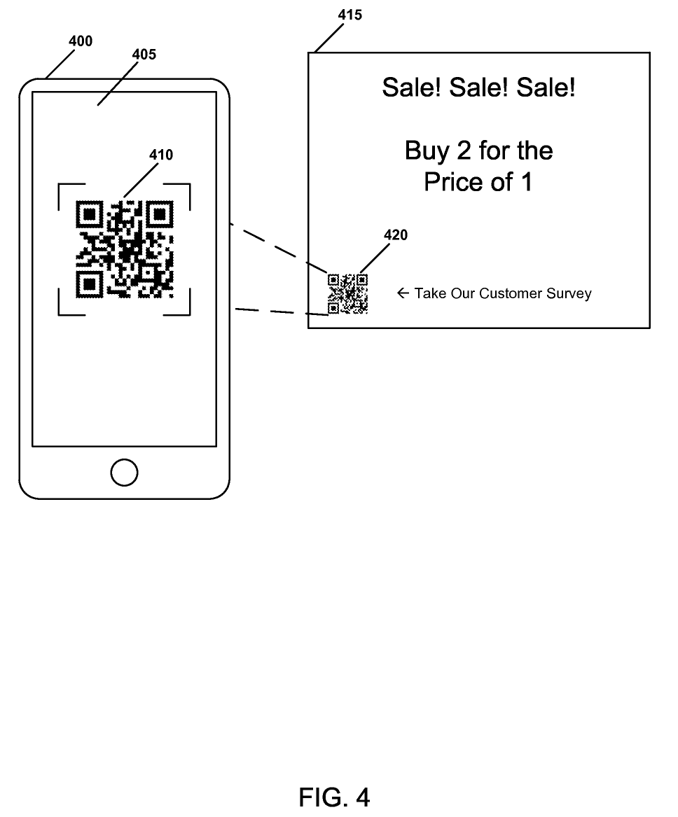

FIG. 2 depicts a flow diagram of an illustrative method of receiving and responding to a poll via a mobile electronic device according to an embodiment. As shown in FIG. 2, an image of a poll symbology may be captured 205 by the mobile electronic device. The image of the poll symbology may be captured 205 using a camera incorporated into the mobile electronic device. For example, the camera may be incorporated into a smartphone or similar device. The poll symbology may include a multi-dimensional bar code. In particular, the poll symbology may include a quick response (QR) code, which is a commonly used two-dimensional bar code. An illustrative displayed poll symbology being captured 205 by a cell phone is depicted in FIG. 4.

In an embodiment, the poll symbology may be displayed as part of a television program or advertisement. In an embodiment, the poll symbology may be displayed in an electronic format over a computer, such as on an Internet website, in an email message, as part of a message on an electronic message board, as part of an Internet advertisement and/or the like. In an embodiment, the poll symbology may be displayed in a tangible or physical format, such as a poster, a product display, or other physical advertisement in a store, a periodical, a paper format, or the like. Each of these embodiments is further described hereinabove.

The mobile electronic device may determine 210 whether the poll symbology is in an expected format. For example, an application on the mobile device may expect certain information to be included in the poll symbology. If such information is not present, the application of the mobile electronic device may determine 210 that the poll symbology is not in the expected format. Alternatively, the mobile electronic device may determine 210 that the poll symbology is in the expected format if certain information is present.

The mobile electronic device may decode 215 the poll symbology to form a sequence. Decoding 215 the poll symbology may be performed by taking a visual format of the poll symbology and translating the poll symbology into a string of characters, such as an alphanumeric sequence, a binary sequence or the like. In an embodiment, decoding 215 the poll symbology may further comprise or alternately comprise decrypting encrypted information.

The mobile electronic device may transmit 220 the sequence to a remote computing device. In an embodiment, the sequence may result from decoding the poll symbology. As such, the sequence may include a string of alphanumeric values, which may represent the information contained in the poll symbology.

The mobile electronic device may receive 225 a poll from the remote computing device. The poll may include a plurality of response items, as described above. Moreover, the poll may be associated with the poll symbology, and the poll may be received 225 in response to transmitting 220 the sequence.

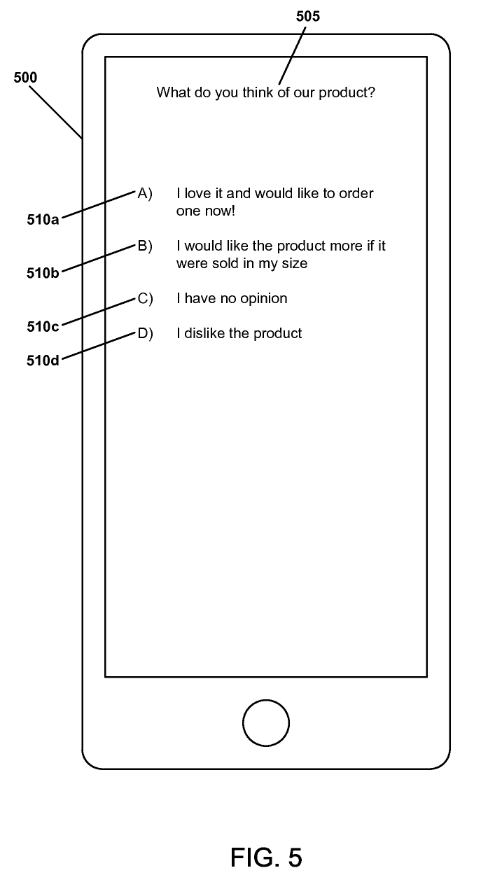

The poll received 225 by the mobile electronic device may be displayed to a user of the mobile electronic device via a display interface. FIG. 5 depicts an illustrative mobile device displaying a poll according to an embodiment.

The mobile device may identify 230 a selected response item of the plurality of response items based on a user input. The selected response item may be identified 230 by a user's interaction with a user interface associated with the mobile electronic device. For example, the user may touch a touch screen in a location associated with the selected response item. In an alternate embodiment, the user may highlight a selected response item and press an enter key. In yet another embodiment, the user may press a key associated with the selected response item. Additional and/or alternate ways of identifying 230 a selected response item based on a user input are intended to be included within the scope of this disclosure.

In an embodiment, at least one of the plurality of response items may be associated with one or more actions to be performed in response to the response item being identified 230 as the selected response item. In an embodiment, the mobile electronic device may transmit a request to perform an action to the remote computing device in response to the selected response item being associated with one or more actions.

Information pertaining to the selected response item may be transmitted 235 to the remote computing device. The information pertaining to the selected response item may include one or more of a selection notification (i.e., that a response was selected) and the selected response item (i.e., the response item that was actually selected). Additional and/or alternate information may also be transmitted 235 within the scope of this disclosure.

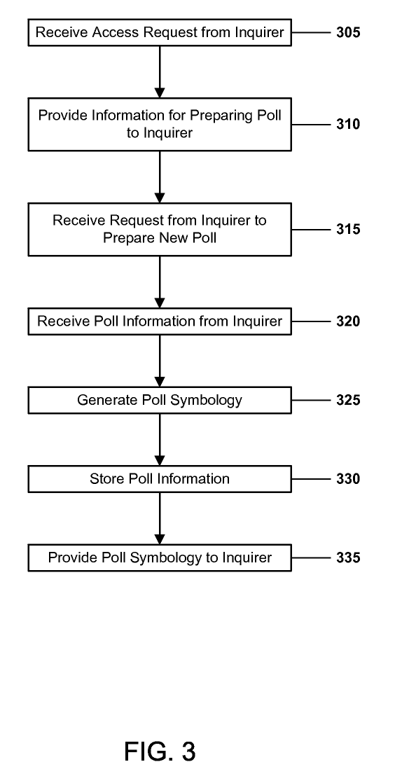

FIG. 3 depicts a flow diagram of an illustrative method of providing a poll for access via a mobile electronic device according to an embodiment. As shown in FIG. 3, an inquirer may log into or otherwise access 305 a computing device. In an embodiment, the inquirer may access 305 the computing device via a Web browser or other user interface over a computer network. In an embodiment, the inquirer may provide one or more credentials identifying the inquirer.

The computing device may provide 310 one or more of a form, instructions, a menu item or the like to the inquirer describing or identifying information to be provided in order to prepare a poll. The inquirer may select 315 an option to prepare a new poll from the user interface.

The computing device may receive 320 poll information from the inquirer. The poll information may include a plurality of response items. In an embodiment, the poll information may further include, for at least one response item, one or more actions to be performed in response to the response item being selected. In an embodiment, the poll information may include a poll name.

The computing device may generate 325 a poll symbology in response to receiving the poll information. The poll symbology may include a multi-dimensional bar code. In particular, the poll symbology may include a quick response (QR) code, which is a commonly used two-dimensional bar code.

The computing device may store 330 the poll information. For example, the poll information may be stored 330 in a database. In an embodiment, the poll information may be stored 330 in association with a representation of a poll symbology. For example, the poll information may be stored 330 in association with a sequence representing the information contained in the poll symbology. In an embodiment, an association between a poll name and a poll symbology may be stored 330.

The computing device may provide 335 the poll symbology to the inquirer. In an embodiment, the computing device may provide 335 the poll symbology to the inquirer via the computer network using the interface described above or a different interface. In an embodiment, the poll symbology may be transmitted in a known computer image format, such as in a JPEG, bitmap or PNG file format.

FIG. 4 depicts an illustrative mobile electronic device being used to capture a poll symbology from a displayed location according to an embodiment. As shown in FIG. 4, a mobile electronic device 400 having, for example, a camera or other scanning unit (not shown—on rear side of device) and a display unit 405 may be used to capture or scan an image 410 of a symbology 420 from a display 415. The display 415 may display the symbology 420 in an electronic or physical form. For example, the display 415 may be a physical display, such as a paper, cardboard, metallic or other similar display. Alternately, the display 415 may be electronic in nature, such as a computer monitor, a television or the like. Additional and/or alternate means of displaying and capturing an image of a symbology may be used within the scope of this disclosure.

FIG. 5 depicts an illustrative mobile electronic device displaying a poll according to an embodiment. As shown in FIG. 5, the mobile electronic device 500 displays a poll question 505 and a plurality of response items, such as 510a-d, as part of a poll. The mobile electronic device 500 may enable selection of one or more of the response items, such as 510a, by a common selection operation, such as touching a touch screen at a location associated with the response item, selecting a key on a keypad, or the like. The mobile electronic device 500 may further transmit and receive information regarding the response items 510a-d in association with the poll.

FIG. 6 depicts a block diagram of illustrative internal hardware that may be used to contain or implement program instructions, such as the process steps discussed above in reference to FIGS. 1-3, according to embodiments. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 6, is an illustrative processing device, computing device or processor as such terms are used within this disclosure. Read only memory (ROM) 610 and random access memory (RAM) 615 constitute illustrative memory devices (i.e., processor-readable non-transitory storage media).

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 630 may permit information from the bus 600 to be displayed on the display 635 in audio, visual, graphic or alphanumeric format. Communication with external devices, such as a print device, may occur using various communication ports 640. An illustrative communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of managing an online poll, the method comprising:
receiving, by a computing device, a sequence representing a poll symbology from a mobile electronic device of a user;
determining, by the computing device, whether the sequence corresponds to a poll of one or more polls stored in a database;
transmitting, by the computing device, the poll to the mobile electronic device, wherein the poll comprises a plurality of response items;
receiving, by the computing device, a selected response item from the plurality of response items from the mobile electronic device; and
storing, by the computing device, the selected response item.

2. The method of claim 1, wherein the poll symbology comprises one or more of a multi-dimensional bar code and a quick response (QR) code.

3. The method of claim 1, further comprising:
determining whether the poll is active.

4. The method of claim 1, further comprising:
determining whether the mobile electronic device has previously responded to the poll.

5. The method of claim 1, further comprising:
receiving, by the computing device, location information from the mobile electronic device; and
transmitting, to the mobile electronic device, statistical information for the poll based on the location information.

6. The method of claim 1, further comprising:
receiving, by the computing device, demographic information for the user from the mobile electronic device; and
transmitting, to the mobile electronic device, statistical information for the poll based on the demographic information.

7. The method of claim 1, further comprising:
receiving, by the computing device, a request to perform one or more actions associated with the selected response item from the mobile electronic device; and
performing, by the computing device, the one or more actions.

8. A method of receiving and responding to a poll via a mobile electronic device, the method comprising:
capturing, by the mobile electronic device, an image of a poll symbology;
determining, by the mobile electronic device, whether the poll symbology is in an expected format;
decoding, by the mobile electronic device, the poll symbology to form a sequence;
transmitting, by the mobile electronic device, the sequence to a remote computing device;
receiving, by the mobile electronic device, a poll from the remote computing device, wherein the poll comprises a plurality of response items, wherein the poll is associated with the sequence;
identifying, by the mobile electronic device, a selected response item of the plurality of response items based on a user input; and
transmitting information pertaining to the selected response item to the remote computing device.

9. The method of claim 8, wherein capturing an image of a poll symbology comprises capturing the image of the poll symbology using a camera incorporated into the mobile electronic device.

10. The method of claim 8, wherein the poll symbology comprises one or more of a multi-dimensional bar code and a quick response (QR) code.

11. The method of claim 8, wherein at least one of the plurality of response items is associated with one or more actions to be performed in response to the response item being identified as the selected response item.

12. The method of claim 11, further comprising:
transmitting, by the mobile electronic device to the remote computing device, a request to perform an action in response to the selected response item being associated with one or more actions.

13. A method of registering a poll for access via a mobile electronic device, the method comprising:
receiving, by a computing device, poll information from an inquirer, wherein the poll information comprises a plurality of response items;
storing, by the computing device, the poll information;
generating, by the computing device, a poll symbology in response to receiving the poll information; and
providing, by the computing device, the symbology to the inquirer.

14. The method of claim 13, wherein the poll symbology comprises one or more of a multi-dimensional bar code and a quick response (QR) code.

15. The method of claim 13, wherein the poll information further comprises, for at least one response item, one or more actions to be performed in response to the response item being selected.

16. The method of claim 13, wherein storing the poll information comprises storing the poll information in association with a representation of the poll symbology.

17. The method of claim 13, wherein the poll information further comprises a poll name, and wherein the poll symbology is associated with the poll name.

18. The method of claim 13, wherein receiving the poll information comprises receiving the poll information via a computer network.

19. The method of claim 13, wherein providing the symbology comprises providing the symbology via a computer network.

20. A system for receiving and responding to a poll, the system comprising:
a computing device; and
a processor-readable storage medium in communication with the computing device, wherein the processor-readable storage medium contains one or more programming instructions that, when executed, cause the computing device to:
capture an image of a poll symbology,
determine whether the poll symbology is in an expected format,
decode the poll symbology to form a sequence,
transmit the sequence to a remote computing device,
receive a poll from the remote computing device, wherein the poll comprises a plurality of response items, wherein the poll is associated with the sequence,
select a selected response item of the plurality of response items based on a user input, and
transmit information pertaining to the selected response item to the remote computing device.

21. The system of claim 20, further comprising:
a camera in operable communication with the computing device,
wherein the one or more programming instructions that, when executed, cause the computing device to capture an image of a poll symbology comprise one or more programming instructions that, when executed, cause the computing device to capture the image of the poll symbology using the camera.

22. The system of claim 20, wherein the poll symbology comprises one or more of a multi-dimensional bar code and a quick response (QR) code.

23. The system of claim 20, wherein at least one of the plurality of response items is associated with one or more actions to be performed in response to the response item being selected.

24. The system of claim 23, wherein the one or more programming instructions further comprise one or more programming instructions that, when executed, cause the computing device to transmit a request to perform an action in response to the selected response item being associated with one or more actions.
